(19) United States
(12) Patent Application Publication
(10) Pub. No.: US 2017/0337923 A1
(43) Pub. Date: Nov. 23, 2017

(54) SYSTEM AND METHODS FOR CREATING ROBUST VOICE-BASED USER INTERFACE

(71) Applicants: Julia Komissarchik, Draper, UT (US); Edward Komissarchik, Draper, UT (US)

(72) Inventors: Julia Komissarchik, Draper, UT (US); Edward Komissarchik, Draper, UT (US)

(21) Appl. No.: 15/592,946

(22) Filed: May 11, 2017

Related U.S. Application Data
(60) Provisional application No. 62/339,015, filed on May 19, 2016.

(51) Int. Cl. G10L 15/26; G06F 3/16; G10L 15/18; G10L 13/04; G10L 15/22

(52) U.S. Cl. CPC G10L 15/265; G10L 15/1822; G10L 13/043; G06F 3/167; G10L 2015/223; G10L 2015/225

(57) ABSTRACT

A system and method for building robust voice-based human-machine interface to improve quality of recognition and usability of the communication is provided.

### FIELD OF THE INVENTION

The present invention relates generally to the field of voice-based human-machine interaction and particularly to a system of creating voice-based dialog systems that provide more accurate and robust communications between human and electronic device.

### BACKGROUND OF THE INVENTION

Voice-based communication with an electronic device (computer, smartphone, car, home appliance) is becoming ubiquitous. Improvement in speech recognition is a major driver of this process. Over the last 10 years voice-based dialog with a machine changed from being a curiosity and most often a nuisance to a real tool. Personal assistants like Siri are now part of many people's daily routine. However, the interaction is still quite a frustrating experience for many. There are several reasons for that—insufficient quality of speech recognition engines, unconstrained nature of interactions (large vocabulary), ungrammatical utterances, regional accents, communication in non-native language. Over last 30 years a number of techniques was introduced to compensate for insufficient quality of speech recognition by using, on the one hand, more restrained dialog/multiple choice model/smaller vocabulary/known discourse, and, on the other hand, adaptation of a speech engine to a particular speaker. The problem with the first group of remedies is that it is not always possible to reduce real life human machine interaction to obey these restrictions. The problem with the second approach (speaker adaptation) is that to provide meaningful improvement the speech engine requires a large number of sample utterance of a user, which means that a user should tolerate insufficient quality of recognition for a while. However, even if this adaptation is accomplished, it still does not address the problem of a conversational nature of the interaction that includes hesitation, repetition, parasitic words, ungrammatical sentences etc. Even such natural reaction as speaking deliberately with pauses between words when talking to somebody who does not understand what was said, throws speech recognition engine completely off. In spite of a lot of efforts made and continued to be made by companies developing speech recognition engines such as Google, Nuance, Apple, Microsoft, Amazon, Samsung and others to improve quality of speech recognition and efficiency of speaker adaptation, the problem is far from being solved.

The drawback of forcing speech recognition engine to try to recognize human speech even if a user has serious issues with correct pronunciation and even speech impediments is that it means the machine is requested to recognize something that is simply not there. This leads to either incorrect recognition of what user wanted to say (but did not) or inability to recognize an utterance at all.

However, voice-based dialogs are typically designed using word and phrase nomenclature as if voice-based dialogs are the same thing as communications using text-based interface. The lack of taking into account the complexity of transforming human speech into text creates a significant impediment to a successful human-machine voice based communication.

In view of the shortcomings of the prior art, it would be desirable to provide a system and methods that can analyze existing voice based dialog nomenclature and advise designers of the system how to change nomenclature, so it conveys same or similar meaning but is easier to pronounce by different groups of users and is less confusing to ASR.

It further would be desirable to provide a system and methods that can analyze the existing voice based dialog nomenclature and pronunciation peculiarities and errors of a user and provide a user with alternative phrases with the same meaning that are less difficult for user to pronounce correctly and that are less confusing to ASR.

It still further would be desirable to provide such a feedback to a user in real time.

### SUMMARY OF THE INVENTION

The present invention is a system and method for building more accurate and robust voice-based interface between humans and electronic devices.

The approach of this invention is not to rely on eventual ability of ASR to recognize (and understand) what user said, but to help user to be better recognized by designing voice-based interfaces around potential pitfalls of speech and speech recognition. The idea is to avoid words and phrases that are problematic for user and/or machine due to phonetical proximity in a language or specific deficiencies in user pronunciation and proclivities of an ASR used.

In view of the aforementioned drawbacks of previously known systems and methods, the present invention provides a system and methods that anticipate what would be problematic in pronunciation and speech recognition for all users or for some categories of users and how to use this knowledge to build more robust user interface. It further provides mechanisms to anticipate what would be problematic in pronunciation and speech recognition for an individual user and advice this user in real time which different words or phrases to use that will convey same or similar meaning that will be easier for ASR to recognize.

In accordance with one aspect of the invention, the system and methods for automatic feedback are provided to assist designers to build more robust voice dialogs for all users or some groups of users by using alternative words and phrases that will convey same or similar meaning, but are less difficult for user to pronounce correctly and are easier for used ASR to recognize.

In accordance with another aspect of the invention, the system and methods for automatic feedback are provided to suggest to individual users in real time alternative phrases with the same or similar meaning that are less difficult for this particular user to pronounce correctly, that are less confusing to ASR and lead to better speech recognition results.

This invention can be used in multiple situations where a user talks to an electronic device. Areas such as Intelligent Assistant, Smartphones, Auto, Internet of Things, Call Centers, IVRs and voice-based CRMs are samples of applicability of the robust dialogs described in this invention.

Though some examples in the Detailed Description of the Preferred Embodiments Invention and in the Drawings are referring to English language, the one skilled in the art will see that the methods of this invention are language independent and can be applied to any language and can be used in any voice-based human-machine interaction based on any speech recognition engine.

### BRIEF DESCRIPTION OF THE DRAWINGS

Further features of the invention, its nature and various advantages will be apparent from the accompanying drawings and the following detailed description of the preferred embodiments, in which:

FIGS. 1 and 2 are, respectively, a schematic diagram of the system of the present invention comprising software modules programmed to operate on a computer system of conventional design having Internet access, and representative components of exemplary hardware for implementing the system of FIG. 1.

FIG. 3 is a schematic diagram of aspects of an exemplary alternative phrase generation system suitable for use in the systems and methods of the present invention.

FIG. 4 is a schematic diagram depicting an exemplary embodiment of robust design feedback system in accordance with the present invention.

FIG. 5 is a schematic diagram depicting an exemplary embodiment of real time user feedback system in accordance with the present invention.

### DETAILED DESCRIPTION OF THE PREFERRED EMBODIMENTS

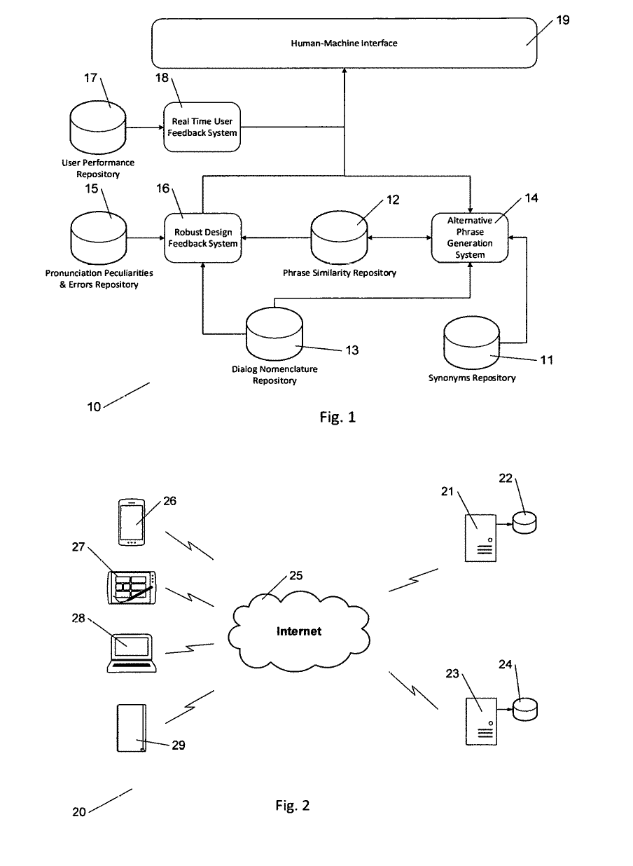

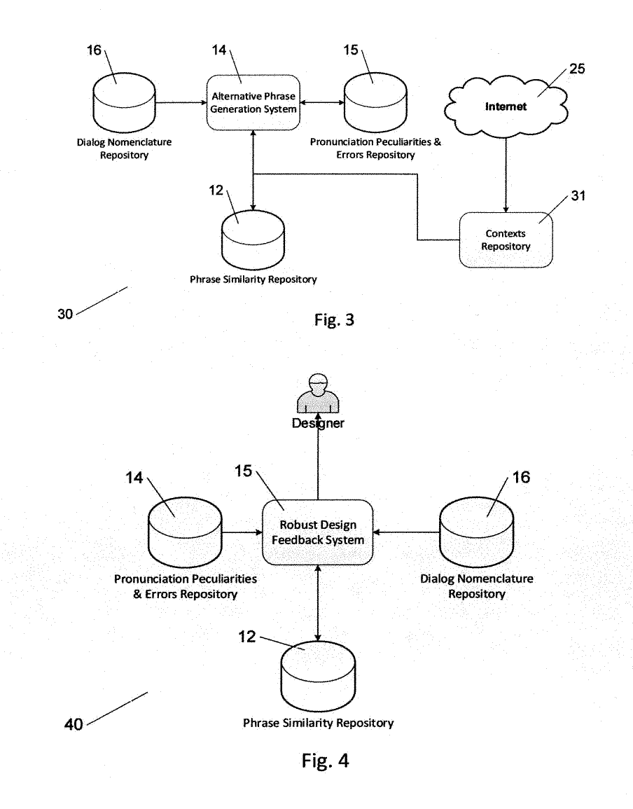

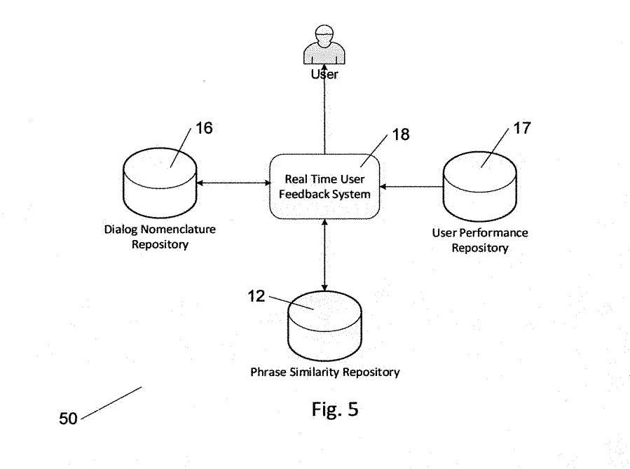

Referring to FIG. 1, system 10 for creating robust voice-based user interface is described. System 10 comprises of a number of software modules that cooperate to build and modify voice-based dialogs by anticipating what can be problematic in talking to a machine for all users or for some categories of users or for an individual user. In particular, system 10 comprise synonyms repository 11, phrase similarity repository 12, dialog nomenclature repository 13, alternative phrase generation system 14, pronunciation peculiarities and errors repository 15, robust design feedback system 16 user performance repository 17, real time user feedback system 18 and human-machine interface component 19.

Components 11-19 may be implemented as a standalone system capable of running on a single personal computer. More preferably, however, components 11-19 are distributed over a network, so that certain components are based on servers accessible via the Internet, while others are stored or have a footprint on personal devices such as mobile phones. FIG. 2 provides one such exemplary embodiment of system 20.

A user using the inventive system and methods of the present invention may access Internet 25 via mobile phone 26, via tablet 27, via personal computer 28, or via home appliance 29. Human-machine interface component 19 preferably is loaded onto and runs on mobile devices 26 or 27 or computer 28, while synonyms repository 11, phrase similarity repository 12, dialog nomenclature repository 13, alternative phrase generation system 14, pronunciation peculiarities and errors repository 15 and robust design feedback system 16 may operate on server side (i.e., server 21 and database 22 correspondingly), while user performance repository 17 and real time user feedback system 18 may operate on server side (i.e. database 24 and server 23 correspondingly), depending upon the complexity and processing capability required for specific embodiments of the inventive system.

Each of the foregoing subsystems and components 11-19 are described below.

Synonyms Repository

Synonyms repository 11 for each language contains words/collocations and their synonyms. The best source of synonymy are thesauri built by linguists. Synonyms from thesauri are stored in Synonyms Repository. The Repository can be represented as a graph. Nodes are words/collocations, while edges between nodes are marked with types of meaning or role. Beside pure synonyms, other relationships can be stored (e.g. hypernyms). Furthermore, canonical (e.g. International Phonetic Alphabet based) phonetic transcription of each node is stored.

Phrase Similarity Repository

While synonyms repository 11 contains synonyms for “official” words and collocations, phrase similarity repository 12 contains phrases and their “unofficial” synonyms for phrases that are important or interesting for a particular field or application. The level of similarity can also go beyond synonymy, so any two phrases can be declared synonyms if either one can be used to communicate certain meaning in a dialog between user and electronic device. This is especially convenient for users that cannot pronounce certain things satisfactorily enough to be understood by ASR. For example, “Jonathan” can be stored as a synonym of “Jon” for the purpose of a smartphone call list. If a user cannot get satisfactory results from ASR while pronouncing the word “Jon”, the system can advise him to say the word “Jonathan” instead. Or, instead of saying “sleet” (and getting the top ASR results like “slit” or “sit” or “seat”) to use a phrase “wet snow” or “melted snow”.

Phrase similarity repository graph is analogous to the one in synonyms repository. However, besides “non-dictionary” nature of this repository each edge between two nodes can contain additional attributes that reflect the reason why this particular relationship between two phrases (nodes) was established. A typical example is provided by a first language of a non-native speaker. If a person with Japanese as the first language speaks English, the edge between, say, the words “rust” and “oxidation” can be stored because the odds for the word “rust” to be mispronounced and misunderstood as “lust” by ASR can be quite high, while the word “oxidation” is not only easier to pronounce it has bigger phonetic distance from other words.

Dialog Nomenclature Repository

Dialog nomenclature repository 13 contains list of words and phrases that are used in voice dialogs between users and machine. The repository 13 can also contain different tags for words and phrases indicating categories and contexts they are used in.

Alternative Phrase Generation System

Alternative phrase generation system 14 takes phrases that are relevant to a particular application and finds phrases that are similar to them in meaning. If a phrase belongs to a thesaurus, then its synonyms that belong to the thesaurus can be a starting point. However, in many cases thesaurus rules of synonymy are too strict for practical applications, where one phrase can be substituted with an alternative phrase that is not exactly synonymous but close enough to lead to the same result in communication with machine. The Alternatives Generation Algorithm deals with that situation.

Let P be a sequence of words. Let N be a number of words in P and P [n] be the n-th word in P. The following algorithm builds a list of phrases that can be used as alternatives for P. Let A [P] be a list of such alternatives. A phrase Q belongs to A [P] if it is used often in the same (relevant to a particular application) contexts as P. Often means over certain threshold that can be defined depending on the application and types of contexts. For example, threshold can reflect absolute or relative number of common relevant contexts for P and Q. Let T be a set of texts relevant to a particular application from contexts repository 31. T can contain texts from multiple websites, or text corpora, etc. Let TH be a thesaurus or union of multiple thesauri. Let NC be a minimum number of words that constitute context. NC can be equal, for example, to 3. Let C (Q) be the number of cases in T that contain a phrase Q with CN words around Q.

Alternatives Generation Algorithm

1. For 1≦I≦N build T [I]—a list of words/phrases from TH that are synonyms of P [I]

2. Build PT—a list of all possible concatenated phrases from T [I] for 1≦I≦N

3. Let M be the number of phrases in PT

4. Set A [P]=Empty

5. For 1≦I≦M

6. If C (P) and C (PT [I]) is smaller than the absolute threshold of occurrence then Continue

7. If C (P)/C (PT [I]) is smaller than the relative threshold of occurrence then Continue

8. Add PT [I] to A [P]

9. Loop

This algorithm can be applied in a similar way to synonyms of collocations that contain more than one word.

Additionally, to increase chances of better recognition it is useful to add some context to the utterance. For example, the chances of correct recognition of the word “pitcher” are lower than the word “picture” because the word “picture” has higher rate of use than the word “pitcher”. However, if instead of “pitcher” a user says “baseball pitcher” the odds of getting this phrase recognized correctly increase. The reason is that ASR will most likely offer both words “picture” and “pitcher” in its N-best list but since “baseball picture” is a rare combination, “baseball pitcher” will be pushed by ASR to the top slot.

Pronunciation Peculiarities & Errors Repository

Pronunciation peculiarities & errors repository 15 contains pairs of phoneme sequences (P1, P2), where P1 is “what was supposed to be pronounced”, while P2 is “what was actually pronounced”. Each pair can have additional information about users that pronounce P2 instead of P1 with some statistical information. If P2=Ø then it means that P1 was not recognized by ASR at all. The examples of the entries in the repository can be [(‘v’, ‘b’), Spanish as First Language], or [(‘l’, ‘r’), Japanese as First Language], or [(‘ets’, ‘eks’), UserID, 90%).

This repository can be built using general phonetics (e.g. minimal pairs) as well as history of users using a particular voice-based user interface.

Robust Design Feedback System

To make voice-based dialog more robust words/phrases used in it should be chosen to be less prone to user mispronunciation and ASR confusion. Major factor in such a confusion is phonetic proximity between different words/phrases. If two words have zero distance in their phonetic pronunciation, they are called homophones. To avoid confusion between homophones human languages are usually built in such a way that homophones have different grammar roles (e.g. “you” vs. “yew”, or “to” vs. “too”). If they just differ in one phoneme, they are called a minimal pair. There are no similar grammar based provisions in a language for minimal pairs though. So, in reality, when user mispronounces a particular phoneme (or sequence of them), words that normally mean totally different things suddenly become de-facto homophones. Quite similar situation takes place for ASR. If two words are pronounced similarly ASR can recognize one word as another. However, if a word/phrase is quite distant from other words/phrases from phonetic standpoint then confusion due to mispronunciation or ASR errors is less likely. That is the premise of the method of building robust voice-based dialogs.

Let S be a set of words/phrases used in a dialog. S can be a short list of commands or a very large list including the whole dictionary and additional application relevant phrases. The distance between two elements from S can be defined, for example, as normalized Levenshtein distance between their phonetical representations using, say, IPA. A word/phrase can have one or more phonetic representations. The following algorithm provides an example on how to find minimal distance in pronunciation between words/phrases. The results of it can be used to choose more robust alternative words/phrases for the dialog that are “further” from other words/phrases than the original word/phrase. This algorithm basically chooses the most “isolated” alternative word/phrase for a word/phrase in a dialog.

Finding Minimal Phonetic Distances between Words/Phrases Algorithm

1. Let P(s) be a set of all phonetic representation of s, where sεS

2. Let L(p, q) be Levenshtein distance for s, tεS, pεP(s), and qεP(t)

3. Set D(s)=maxint

4. For each tεS, t≈s

5. Let m=L(p, q) for all pεP(s) and qεP(t)

6. If D≦m Continue

7. D(s)=m

8. Loop

D(s) is the minimal distance of all possible pronunciations to all possible pronunciations of all other words/phrases from S. D(s) is a measure of “remoteness” that allows to choose instead of one word/phrase another one that can be less “confusing” for ASR to recognize and/or for user to mispronounce.

Using this algorithm for any word/phrase at the design phase will allow to build a more robust voice-based human-machine interface. The dialogs can be tuned at the design phase to recover from typical errors of non-native speakers that share the same first language.

There are two major cases of finding the most “remote” alternative word/phrase in a voice-based interface at the design phase:
First Language—expand canonical phonetic representation to cover pronunciation peculiarities/errors typical for speakers with a particular first language or dialect
Individual—expand canonical phonetic representation to include particular user pronunciation peculiarities/errors and to exclude from the list of alternatives words/phrases that often produced no results from ASR

Pronunciation peculiarities/errors of a group (e.g. people that share common first language) or an individual introduce “disturbances” into the relationships between entries in Synonyms and Phrase Similarity Repositories. For example, two words/phrases from these repositories suddenly become undistinguishable (homophones) or can easily confuse ASR. This is as if repository “contracts” and words/phrases became “glued” together. So the phrases that were good alternatives become less desirable. Furthermore, certain words/phrases become simply unusable because user cannot reliably pronounce them and ASR provides no results at all.

User Performance Repository

User performance repository 17 contains historical and aggregated information of individual users' pronunciation. It is similar to pronunciation peculiarities & errors repository 15 but stores information about individual users' pronunciation peculiarities and errors. One of the ways to build this repository is described in U.S. Patent Application 62/339,011 (which is incorporated here by reference).

Real Time User Feedback System

Real time user feedback system 18 works using similar principles as robust design feedback system 16 but its feedback is based on pronunciation patterns of a particular user. The system 18 uses the same algorithm to calculate phonetic distances between words/phrases but takes information about phonemes confusion (e.g. coming from minimal pairs or transpositions) that are specific for each individual user.

Moreover, the system 18 does it on the fly. For example when adding an entry to call list on a smartphone, this algorithm can advise user to use an alternative that would be recognized more reliably. For example, if a user has difficulties with a minimal pair ‘v-b’ the Levenshtein distances will be calculated with zero penalties for (v, b) substitution. One way to implement this is to associate with each word/phrase a set of pronunciations that includes a canonical phonetic representation as well as all possible substitutions of sequences of phonemes that user frequently mispronounced.

Furthermore, the system 18 excludes words/phrases pronounced by a particular user that ASR consistently cannot recognize and substitute them with the words/phrases of similar meaning from phrase similarity repository 12 that consist of phoneme sequences that this user can pronounce correctly.

Human-Machine Interface System

The human-machine interface system 19 is designed to provide designer of voice-based dialog system feedback on what kind of changes the designer can make to improve quality of recognition and thus usability of the system being designed. The feedback is based on the idea.

What is claimed is:

1. A system for creating robust voice-based user interface comprising:
an alternative phrase generation module that takes words and phrases present in a human-machine interface and builds a set of words and phrases that convey similar meaning but would be less prone to pronunciation errors and incorrect speech recognition;
a design feedback module that takes into account pronunciation peculiarities and errors of target users and used ASR and provides system designer with recommendations on how to change existing words and phrases nomenclature to a nomenclature that conveys same or similar meaning but would be more reliably recognized by ASR;
a user feedback module that takes into account pronunciation peculiarities and errors of a particular user and provides user with recommendations on how to change the words and phrases user uses in communication with the machine to words and phrases that convey same or similar meaning but would be more reliably recognized by ASR;
a human-machine interface that communicates to designer the recommendations of the design feedback module; and
a human-machine interface that communicates visually or aurally the recommendations of the user feedback module.

2. The system of claim 1 comprising of pronunciation peculiarities and errors repository accessible via internet, wherein different peculiarities and errors characteristic to groups of users are stored corresponding to their types.

3. The system of claim 1, further comprising of a performance repository accessible via the Internet, wherein individual users' mispronunciations and speech peculiarities are stored corresponding to their types.

4. The system of claim 1, further comprising of a phrase similarity repository that contains words and phrases that convey same or similar meaning as the words and phrases in the existing human-machine dialog, but will be more reliably recognized by ASR.

5. The system of claim 1, further comprising of an alternative phrase generation system that builds alternative words and phrases that convey same or similar meaning as the words and phrases in the existing human-machine dialog but will be more reliably recognized by ASR and stores them in a phrase similarity repository accessible via the Internet.

6. The system of claim 1, further comprising of a design feedback module that takes into account pronunciation peculiarities and errors of target users and used ASR and provides system designer with recommendations on how to change existing words and phrases nomenclature to a nomenclature that conveys the same or similar meaning but would be more reliably recognized by ASR;

7. The system of claim 1, further comprising of a user feedback module that takes into account pronunciation peculiarities and errors of this particular user and provides user with recommendations on how to change words and phrases user uses in communication with the machine to words and phrases that convey the same or similar meaning but that would be more reliably recognized by ASR;

8. The system of claim 1 wherein a human-machine interface is configured to operate on a mobile device.

9. A method for creating robust voice-based user interface comprising:
using internet, thesauri and other sources to build alternative words and phrases that convey same or similar meaning to the words and phrases in the existing human-machine dialog but that are more reliably recognized by ASR;
providing guidance to voice-based dialog designer;
building guidance to the user on how to improve the results of speech recognition by changing the words and phrases user uses in communication with the machine to words and phrases that convey the same or similar meaning but that would be more reliably recognized by ASR; and
providing guidance to the user visually or aurally.

10. The method of claim 9, wherein the feedback on improving the results of ASR is provided to the user in real time.

11. The method of claim 9, wherein the communication with the user is performed using a mobile device.
